(19) United States
(12) Patent Application Publication
(10) Pub. No.: US 2017/0086259 A1
(43) Pub. Date: Mar. 23, 2017

(54) Serpentine film heater for adjusting temperature uniformity and temperature adjusting method thereof

(71) Applicant: University of Electronic Science and Technology of China, Chengdu (CN)

(72) Inventors: Xiaosong Du, Chengdu (CN); Yaru Li, Chengdu (CN); Yuming Wu, Chengdu (CN); Qi Yao, Chengdu (CN); Pengfei Guo, Chengdu (CN); Huan Yuan, Chengdu (CN); Huiling Tai, Chengdu (CN)

(21) Appl. No.: 15/371,205

(22) Filed: Dec. 7, 2016

(30) Foreign Application Priority Data
Aug. 17, 2016 (CN) 201610679915.9

(51) Int. Cl. H05B 3/34; H05B 3/26

(52) U.S. Cl. CPC H05B 3/34; H05B 3/265; H05B 2203/003; H05B 2203/037

(57) ABSTRACT

The present invention relates to a serpentine film heater for adjusting temperature uniformity and a method of temperature adjusting, including a substrate and a serpentine film heating wire which is deposited on the substrate, wherein the serpentine film heating wire is formed by several parallel heating sections and connecting lines. In the longitudinal direction, the temperature uniformity is improved by adjusting the spacings between adjacent heating sections or line widths of the heating sections separately or in combination. In the transverse direction, the every heating section is adjusted to a shape which is wide in center and narrow at two ends. By adjusting the spacings and line widths in both transverse and longitudinal directions the present invention reduces heating power in the central part of the substrate and increases the heating power on the edges, thus compensates the heat transfer difference between center and edges and improves the temperature uniformity.

### CROSS REFERENCE OF RELATED APPLICATION

This application claims priority under 35 U.S.C. 119(a-d) to CN 201610679915.9, filed Aug. 17, 2016.

### BACKGROUND OF THE PRESENT INVENTION

Field of Invention

The present invention relates to temperature control field, and more particularly to a serpentine film heater for adjusting temperature uniformity and a temperature adjusting method thereof.

Description of Related Arts

Temperature control has wide applications in different industries. A typical temperature control system includes two parts: a heater or a cooler and corresponding temperature control circuit or temperature control instrument. With the miniaturization development of the electronic devices, the heater adopting thin-film or thick-film technology has been widely applied.

In practical applications the thin-film or thick-film heater has to meet certain requirements on temperature uniformity. For example, the temperature inside the whole trench area of a micro-chromatograph column is required to be as uniform as possible, otherwise the chromatographic peak broadens seriously that greatly lower the separation performance of the chromatography column.

The main factors that affect the temperature uniformity can be summarized to the following two points:
1) the thermal conductivity of the substrate
For the thick/thin film heater, a heating wire is deposited on the substrate; when electrify the heating wire, heat will be generated by the wire and then conducted to the substrate. So the conductivity of the substrate significantly affects the temperature uniformity. The commercialized flexible film heater adopts polymers such as polymide (PI) as the substrate. Low conductivity of the polymer inevitably degrades the temperature uniformity. On the contrary, silicon has good conductivity, thus it is adopted predominately as the substrate for a conventional micro-chromatograph column.
2) the geometry layout of the heating wire
The heating line is conventionally deposited on the flat plate substrate by photolithography or screen printing technology. The geometry layouts of the heating line can be roughly classified as: (1) serpentine, please refers to literature \textcircled{1} Design and fabrication of micro hydrogen gas sensors using palladium thin film. Mater ChemPhys, 2012, 133:987; \textcircled{2} JP200479492A; (2) circular, please refers to literature \textcircled{3} Micro-hot-plates without simply connected hot-spots and with almost-circular temperature distribution, Sens. Actuators B, 2013, 185: 274; \textcircled{4} JP2000150119A; (3) arbitrary wandering shape, please refers to literature \textcircled{5} JP 2009176502A; (4) double spiral, please refers to literature \textcircled{6} Reliability improvement of suspended platinum-based micro-heating elements, Sens. Actuators A, 2008, 142: 284; \textcircled{7} Electro-thermal analysis of MEMS microhotplates for the optimization of temperature uniformity. Procedia Eng, 2011, 25:387; and (5) others. In order to heating the substrate evenly, the present technology conventionally arranges the heating wire on the predetermined area evenly. This arrangement doesn't fully consider the boundary condition of the heat transfer, since the heat dissipation is slow in the central part of the substrate and fast on the edges, which causes the temperature higher in the center than on the edges. As in the literature \textcircled{1}, the heating material is a multilayer film of 2 μm Si₃N₄/30 nm Ta₂O₅/300 nm platinum/500 nm SiO₂. The platinum heating film is in a regular serpentine shape. When the temperature in the center reaches 154° C., the temperature on the edge is around 140° C., demonstrating a relative large temperature non-uniformity of 10%. Based on this knowledge, the width of the heating line in some of the double spiral heaters as showed in literature \textcircled{6} and \textcircled{7}, was designed to be wider in the center of the micro-hotplate to decrease the current density and thus the temperature. However, double spiral layout is only suitable for a square or square-like substrate. Therefore, the thick/thin film heater, especially the serpentine heater in conventional technology can not realize a higher degree of the temperature uniformity.

### SUMMARY OF THE PRESENT INVENTION

An object of the present invention is to provide a serpentine film heater for adjusting the temperature uniformity and a method for temperature adjusting using the film heater, which solves the problem of uneven heating temperature provided by the conventional heaters and thus improves temperature uniformity.

Accordingly, in order to accomplish the above object, the present invention provides a serpentine film heater for adjusting temperature uniformity, comprising a substrate on which a serpentine film heating wire is deposited, wherein the substrate is in a rectangle, parallelogram or square shape; the serpentine film heating wire is formed by several parallel heating sections and connecting lines; for each of the heating sections the line width is wide in a central part and narrow at two ends; amongst the heating sections the line widths are different or the spacings are different or both the line widths and spacings are different.

When the heating sections have the same line widths but different spacings, the spacings are wide in a central part of the substrate and narrow at two sides of the substrate.

When the heating sections have the same spacings but different line widths, the line widths are wide in a central part of the substrate and narrow at two sides of the substrate.

The optimum shape of every heating section which is wide in the center and narrow at two ends is a pair of arcs.

The connecting line is a short line or a 180° bend.

The material for the serpentine film heating wire includes single element metal of platinum, gold, copper, and tungsten, copper alloy, nichrome alloy and doped polycrystalline silicon.

The substrate is a flat plate sheet which is made by material including a semiconductor substrate, a glass sheet, a ceramic sheet, a quartz sheet, a passivated metal sheet, a single layer dielectric film, a multilayer dielectric film, a multilayer metal/dielectric composite film, and a flexible polymer film.

Another object of the present invention is to provide a method for adjusting the temperature uniformity, comprising a two-dimensional flat sheet substrate on which a serpentine film heating wire is deposited, wherein the serpentine film heating wire is formed by several parallel heating sections and connecting lines; along a longitudinal direction of the substrate the spacing between the heating sections or line width of the heating section is able to be fine tuned separately or in combination to improve the temperature uniformity in the longitudinal direction; along a transverse direction of the substrate the shape of every heating section is able to be fine tuned to be wide in center and narrow at two ends to improve the temperature uniformity in the vertical direction.

In the longitudinal direction of the substrate the spacings between the neighboring heating sections are wide in the center of the substrate and narrow at two sides of the substrate.

In the longitudinal direction of the substrate the line widths of the heating sections are wide in the center of the substrate and narrow at two sides of the substrate.

The benefit of the present invention is that it takes the boundary condition of the heat dissipation into consideration and thus discards the design method of equal power supply for every part of the heater. The power in a central part of the heater is slightly smaller than on the edges, which effectively improves the temperature uniformity of the heater. Under the same active area coiled by the serpentine film heating wire the temperature uniformity is better than the conventional heater. Moreover, the present invention provides a two-dimensional temperature uniformity adjusting method, namely, the temperature uniformity in the longitudinal and transverse directions can be adjusted separately. On the contrary, the double spiral heater can only adjust the temperature uniformity along one direction (radial), since its geometry can be roughly described by a polar coordinate. As a result, the serpentine heater of the present invention can be arranged on a wider type of substrate such as rectangular, which is not suitable for the double spiral heater.

### BRIEF DESCRIPTION OF THE DRAWINGS

FIG. 1 illustrates the prior art of an electrode pattern of the serpentine heater with equal spacing;

FIG. 2 illustrates a two dimensional temperature distribution of the serpentine heater with equal spacing;

FIG. 3 illustrates temperature profiles of the serpentine heater with equal spacing in longitudinal (a) and—transverse (b) direction;

FIG. 4 illustrates an electrode pattern of the serpentine heater with varying spacing;

FIG. 5 illustrates a two dimensional temperature distribution of the serpentine heater with varying spacing;

FIG. 6 illustrates temperature profiles of the serpentine heater with varying spacing in longitudinal (a) and transverse (b) direction;

FIG. 7 illustrates the electrode pattern of the heater of an embodiment 1 of the present invention;

FIG. 8 illustrates a two dimensional temperature distribution of the heater of the embodiment 1 of the present invention;

FIG. 9 illustrates temperature profiles of the heater in the embodiment 1 of the present invention in longitudinal (a) and transverse (b) direction;

FIG. 10 illustrates the electrode pattern of the heater of an embodiment 2 of the present invention;

FIG. 11 illustrates a two dimensional temperature distribution of the heater of the embodiment 2 of the present invention;

FIG. 12 illustrates temperature profiles of the heater in the embodiment 2 of the present invention in longitudinal (a) and transverse (b) direction;

Element reference: 1—serpentine film heating wire, 2—substrate, S1, S2, S3, S4; S1′, S2′ S3′ S4′—spacing between heating sections in different position respectively, W1, W2, W3, W4, W5; W1′, W2′ W3′ W4′ W5′—line width in different positions respectively, L1—effective distance in longitudinal direction, L2—effective distance in transverse direction.

### DETAILED DESCRIPTION OF THE PREFERRED EMBODIMENT

Referring to the drawings, in order to better illustrate the intention, technical solution and advantage of the present invention further explanations are as below.

According to a preferred embodiment of the present invention is illustrated, comprising a serpentine film heater for adjusting temperature uniformity and a method for adjusting temperature thereof, which solves the problem of uneven temperature provided by the conventional heaters and thus improves temperature uniformity.

In order to solve the problem of uneven temperature distribution provided by the conventional film heater technology, referring to the drawings and two preferred embodiments of the present invention, detailed explanations on the technical solution of the present invention are listed below.

In the conventional technology the spacing between the heating sections is a fixed figure as illustrated in FIG. 1. The Si₃N₄ film substrate sized 7.5 mm×3.5 mm×1 um, on which a platinum film heater with a thickness of 200 nm is deposited. The platinum film heater coiled on the Si₃N₄ substrate in a serpentine shape with 9 sections. The neighboring heating sections are connected with a short line of 400 um. The line width of the heating sections as well as the connecting lines is identical which gives W1=W2=W3=W4=W5=400 um. The spacing between the neighboring heating sections is also 400 um represented by S1, S2, S3, S4 respectively from the central part of the substrate to the edge. The film heating wire covers a substrate area sized 6.8 mm×2.8 mm. Based on the basic theory of Joule heating and heat transfer, heating temperature is simulated with software COMSOL.

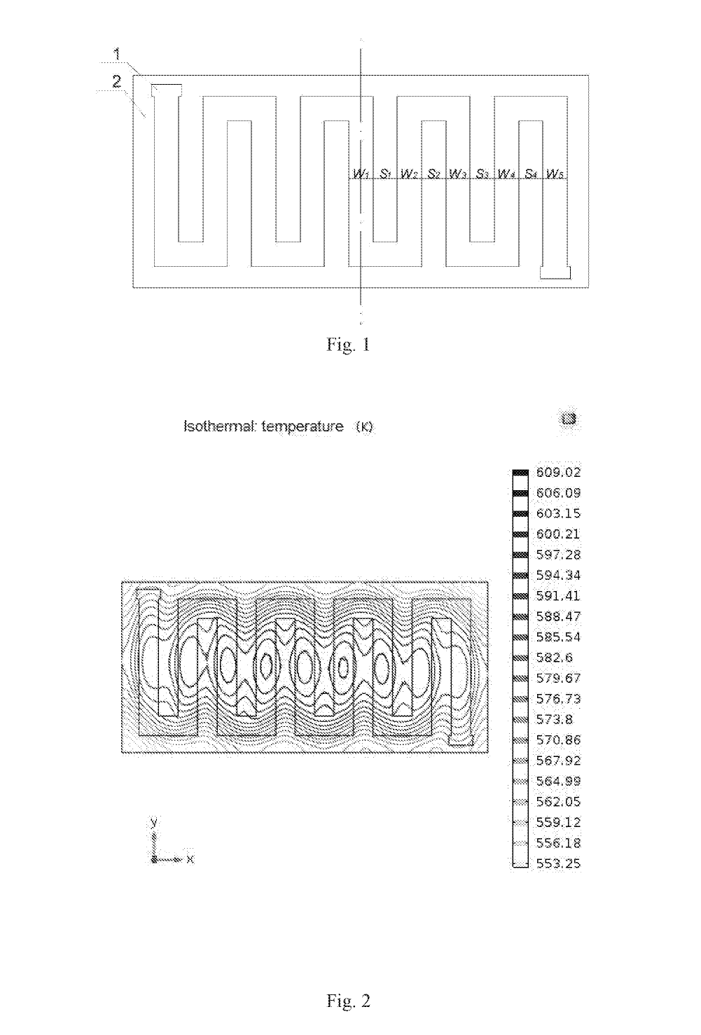

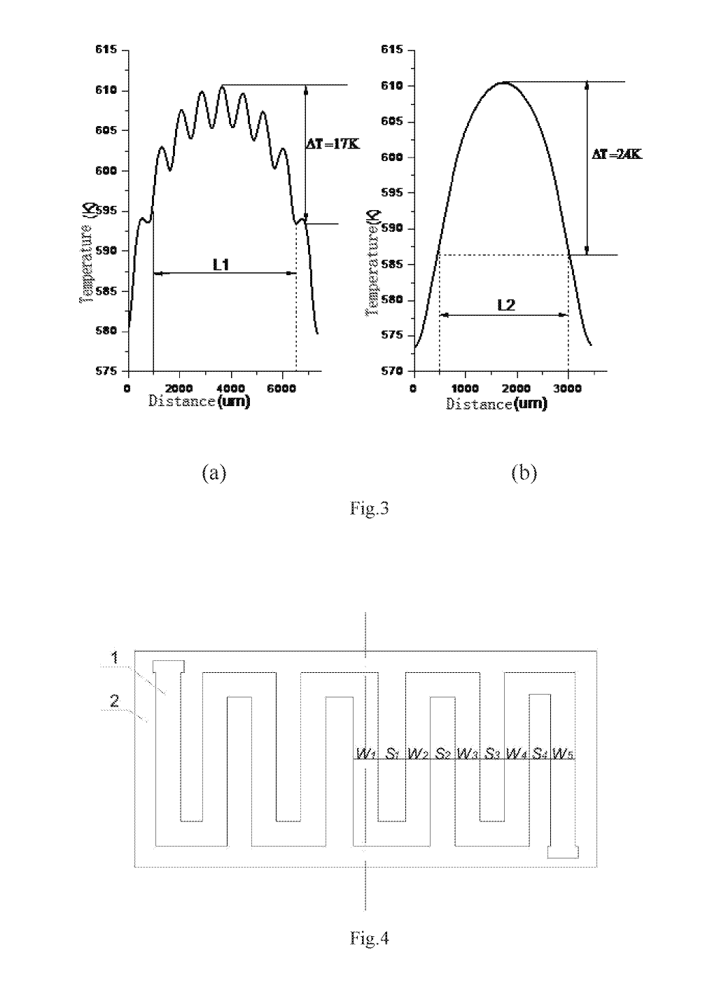

In the process of simulation the Joule heating module is adopted and in the process of heat transfer the conduction and convection are taken into consideration and the radiation is ignored. When applies a given voltage on two ends of the heating wire, the two dimensional temperature distribution of the Si₃N₄ substrate in equilibrium stage is illustrated in FIG. 2. The temperature profile of the central part of the substrate along the X axis (longitudinal) is illustrated in FIG. 3(a), within the central effective area of 1000-6500 um along the longitudinal direction (exclude two outermost heating sections) the generated temperature difference is 17K. The temperature profile of the central part of the substrate along the Y axis (transverse) is illustrated in FIG. 3(b), within the central effective area of 500-3000 um along the transverse direction (include part of the connecting lines) the generated temperature difference is 24 K. The conclusion is that the temperature in the central part of the heater is highest and on the edge part is lowest thus the temperature gradient is large. The temperature shows a rapidly oscillating down trend along the X axis from center to edge, which is caused by slightly higher temperature of the platinum heating wire than the neighboring Si₃N₄ substrate. On the contrary, the temperature along the Y axis decreases monotonically and more rapidly from center to edge. The reason for the resulted temperature distribution is the temperature dissipation is slower in the center of the heater than on the edge, which proves that to distribute the heating wire with equal spacing doesn't take the boundary condition into consideration and inevitably causes a big temperature difference between the center and the edge.

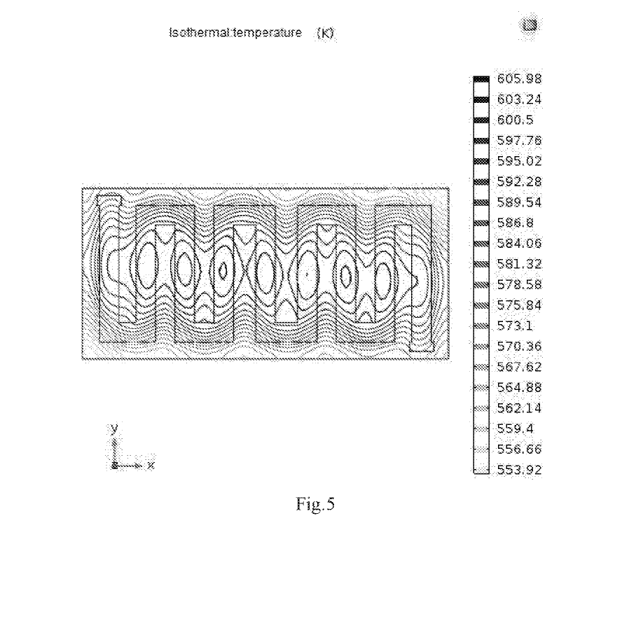

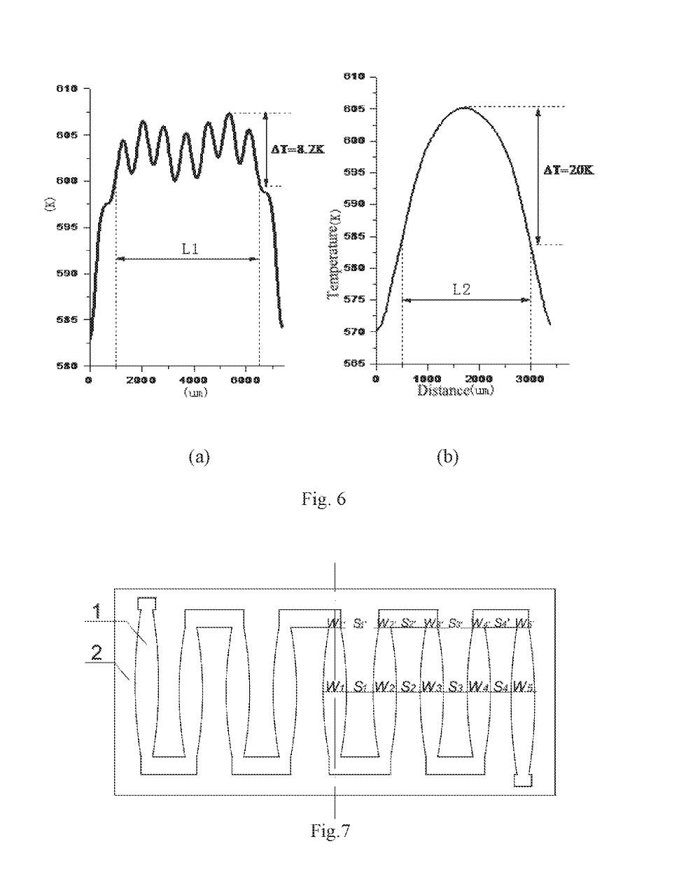

In order to improve the temperature uniformity of the conventional serpentine heater the heating power in the central part need to be lowered and correspondingly increase the heating power on the edge. The geometry layout of the heating wire is optimized by changing the electrode spacing between the heating sections. Based on FIG. 1, the line width remains unchanged, which is W1=W2=W3=W4=W5=400 um; the spacings between the heating sections are adjusted to S1=450 um, S2=S3=400 um, S4=350 um respectively. As illustrated in FIG. 4, the heating wire covers the same area on the substrate as in FIG. 1. After reaching heating transfer equilibrium the two dimensional temperature distribution of the Si₃N₄ substrate is illustrated in FIG. 5. The temperature profile of the central part of the substrate along the X axis (longitudinal) is illustrated in FIG. 6(a), within the central effective area of 1000-6500 um along the longitudinal direction the generated temperature difference is 8.2K. Compared to the electrode pattern with identical spacing between the heating sections as illustrated in FIG. 3(a), the temperature uniformity is improved obviously. In the longitudinal direction, the highest temperature point is located on the 3^{rd} heating sections from the center to the edge rather than on the central most heating section. The temperature profile of the central part of the substrate along the Y axis (transverse) is illustrated in FIG. 6(b), within the central effective area of 500-3000 um along the transverse direction the generated temperature difference is 20 K. Compared to FIG. 3(b), the temperature distribution varies insignificantly. The conclusion is that by just adjusting the spacing between the heating sections or based on the same theory by adjusting the line width of the heating wire or by adjusting the spacing and line width in combination, the temperature uniformity is able to be improved effectively in one direction (X axis in this case), but no remarkable improvement can be made in its transverse direction (Y axis in this case). This is because under the above adjustment, the spacing as well the line width is identical everywhere along each heating section, causes an equal power supply on every part of the heating wire, thus the design requirement of reducing the heating power in the central part is not able to be met.

Based on the analysis, in order to further improve the temperature uniformity in the transverse direction the conventional technical method of adopting an unchanged line width for a serpentine heater should be discarded. Every heating section should be designed as wide in a central part and narrow at two ends and the line width monotonically decreases from the center to the two ends.

### Embodiment 1

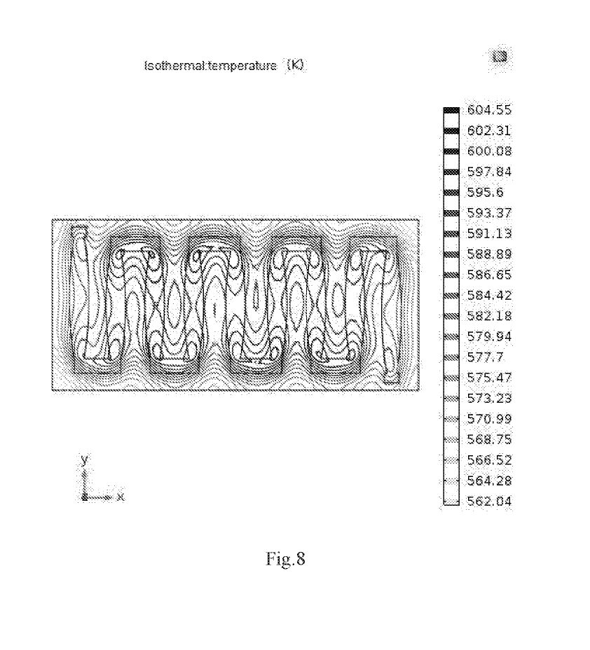

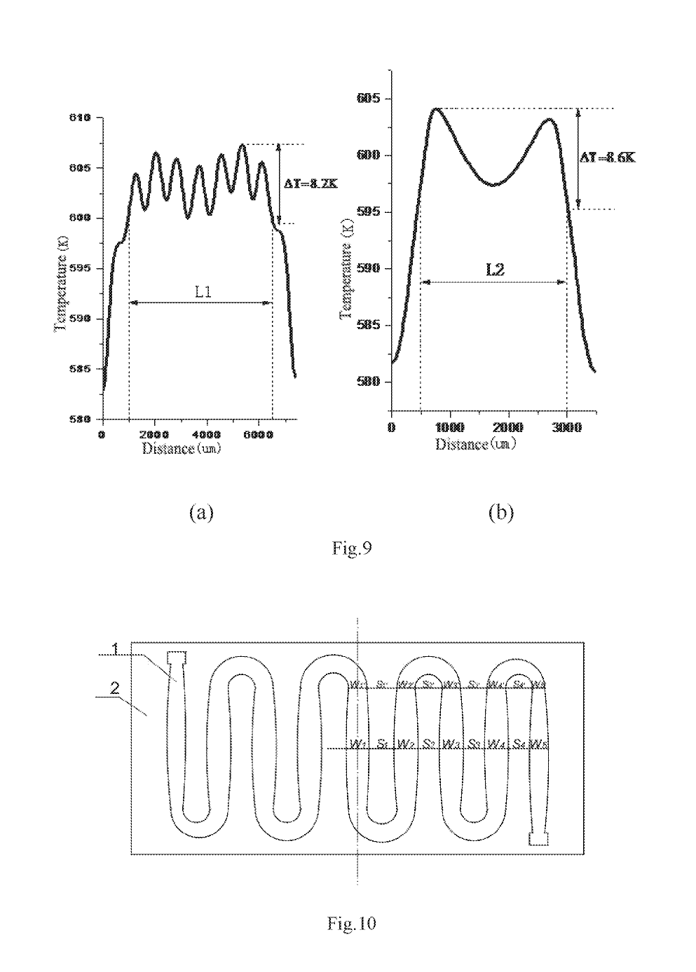

In the embodiment 1 of the present invention, the spacing between every heating section is adjusted in the longitudinal direction and meanwhile the line width is adjusted in the transverse direction as well. First the spacing between every heating section is being adjusted according to the electrode pattern illustrated in FIG. 4; then the line width is optimized to be wide in the center and narrow at two ends. There are 4 steps in the process of line width optimization. (1) The spacing and line width of each heating section remain unchanged in the central part of the substrate as compared to FIG. 4, namely, W1=W2=W3=W4=W5=400 um; S1=450 um, S2=S3=400 um, and S4=350 um; (2) The line widths at two ends of the heating sections are narrowed down to W1′=W2′=W3′=W4′=W5′=200 um and the spacings are widened to S1′=650 um, S2′=S3′=600 um, S4′=550 um correspondingly. (3) The connecting lines between the heating sections are reduced to 300 um, thus the area covered by the serpentine film heating wire on the substrate remains unchanged. (4) The 6 predetermined points (two in the center, four at two ends) on every heating section are connected by a pair of arcs, which forms the heating section patterns and in turn consists of the whole heater pattern of this embodiment as illustrated in FIG. 7. As illustrated in FIG. 8, the two dimensional temperature distribution of the Si₃N₄ substrate after reaching heat transfer equilibrium indicates that the highest temperature point is not in the central or near the central part but on the turning points of the connecting lines which located on the sub-center. The temperature profile of the central part of the substrate along the X axis (longitudinal) is illustrated in FIG. 9(a). Within the central effective area of 1000-6500 um along the longitudinal direction the generated temperature difference is 9.1K. The temperature profile of the central part of the substrate along the Y axis (transverse) is illustrated in FIG. 9(b), which is low in the middle and high at two ends thus presenting a saddle shape. Within the central effective area of 500-3000 um along the transverse direction, the temperature difference is significantly reduced to 8.6 K. It must be pointed out that the temperature profile illustrated in FIG. 9(b) does not pass through the point of highest temperature. If the temperature profile passes through the point of highest temperature similar patterns as illustrated in FIG. 9(b) will be generated, which only differs in that the middle part of the saddle is lower, but the temperature difference is small within the observation range of L2. The conclusion is that by adopting the method illustrated in the present embodiment the temperature uniformity improved significantly in both longitudinal and transverse directions.

### Embodiment 2

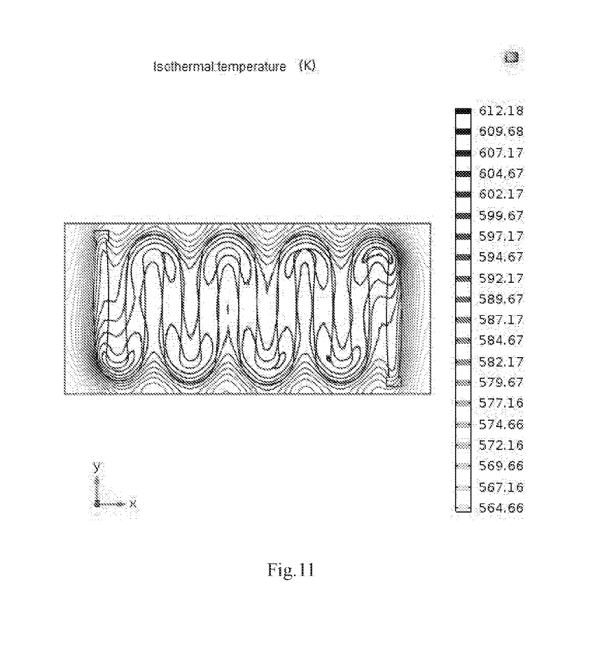

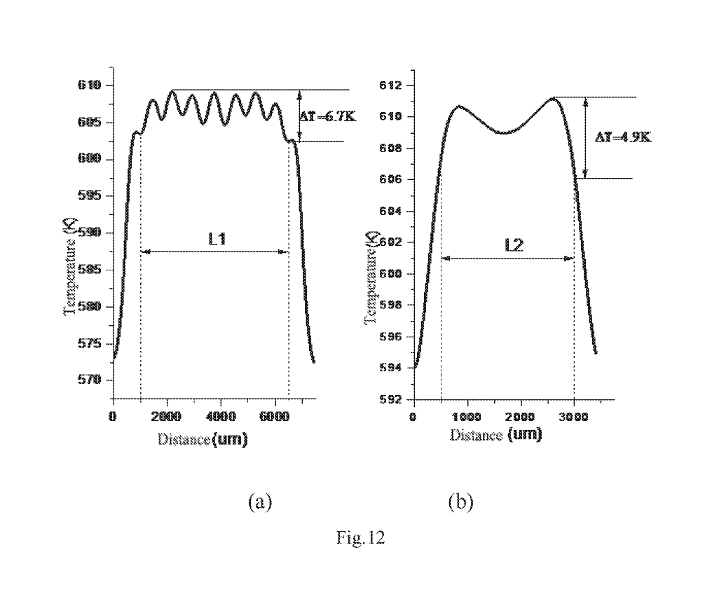

In order to further improve the temperature uniformity, in embodiment 2 we adopting a method of adjusting the spacing and line width of every heating section in combination to further improve the temperature uniformity in the X axis direction. Based on the conventional electrode pattern of identical spacing and identical line width as illustrated in FIG. 1, the line widths are adjusted to W1=380 um, W5=310 um, W2=W3=W4=400 um; and the spacings are adjusted to S1=410 um, S2=S3=S4=350 um. It must be pointed out that when adopting the method of adjusting the spacing or the line width separately, it is required that the spacing or the line width is wide in the center of the heater and narrow on edges; but if adopting the combined adjusting method it is not limited by the above requirement. Subsequently, every heating section is optimized by changing the line width, which is wide in the center and narrow at two ends. In the process of optimizing, first the spacing and line width in the central part of heating section remain unchanged, namely, W1=380 um, W2=W3=W4=400 um, W5=310 um; S1=410 um, S2=S3=S4=350 um. Second the line widths at two ends of the heating section are narrowed down to W1′=W2′=W3′=W4′=300 um, W5′=200 um, and correspondingly the spacings between the heating sections are increased to S1′=500 um, S2′=S3′=450 um, S4′=455 um. Connecting the 6 predetermined points (two in the center, four at two ends) on every heating section by a pair of arcs and connecting the neighboring heating sections with 180° arcs, which forms the heater pattern as illustrated in FIG. 10. The two dimensional temperature distribution of the Si₃N₄ substrate after reaching heating transfer equilibrium is illustrated in FIG. 11, which shows that in a large central area of the heater there are barely distributed isotherms, indicating that in the area the temperature difference is just around 3K. The highest temperature on the substrate appears at the 180° connecting arc. The whole inner side of the arc is almost covered by a same isotherm. Therefore, the temperature uniformity of embodiment 2 is better than embodiment 1. The temperature profile of the central part of the substrate along the X axis (longitudinal) is illustrated in FIG. 12(a). Within the central effective area of 1000-6500 um along the longitudinal direction the generated temperature difference is 6.7K. The temperature profile of the central part of the substrate along the Y axis (transverse) is illustrated in FIG. 12(b), which passes through the highest temperature area at the 180° arc and is low in the center and high at two ends thus presenting a saddle shape. Within the central effective area of 500-3000 um, the temperature difference is very small, which is only 4.9K. The conclusion is that by adopting the method illustrated in the embodiment 2 the temperature uniformity is not only remarkably improved in the longitudinal direction but also in the transverse direction as compared to the embodiment 1.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A serpentine film heater for adjusting temperature uniformity, comprising: a substrate and a serpentine film heating wire which is deposited on the substrate, wherein the substrate is in a rectangle, parallelogram or square shape; the serpentine film heating wire is formed by several parallel heating sections and connecting lines; wherein the line width of each of the heating sections is wide in a central part and narrow at two ends; wherein the line widths of different heating sections or the spacings between the adjacent heating sections are different or both the line widths and spacings are different.

2. The serpentine film heater for adjusting the temperature uniformity, as recited in claim 1, wherein when the heating sections have the same line widths but different spacings the spacings are wide in a central part of the substrate and narrow at two sides of the substrate.

3. The serpentine film heater for adjusting the temperature uniformity, as recited in claim 1, wherein when the heating sections have the same spacings but different line widths the line widths are wide in a central part of the substrate and narrow at two sides of the substrate.

4. The serpentine film heater for adjusting the temperature uniformity, as recited in claim 1, wherein the optimum shape of every heating section which is wide in the center and narrow at two ends is a pair of arcs.

5. The serpentine film heater for adjusting the temperature uniformity, as recited in claim 1, wherein each of the connecting lines is a short line or a 180° bend.

6. The serpentine film heater for adjusting the temperature uniformity, as recited in claim 1, wherein a material for the serpentine film heating wire comprises single element metal of platinum, gold, copper and tungsten, copper alloy, nichrome alloy and doped polycrystalline silicon.

7. The serpentine film heater for adjusting the temperature uniformity, as recited in claim 1, wherein the substrate is a flat plate sheet which is made by material comprising a semiconductor substrate, a glass sheet, a ceramic sheet, a quartz sheet, a passivated metal sheet, a single layer dielectric film, a multilayer dielectric film, a multilayer metal/dielectric composite film, and a flexible polymer film.

8. A method for adjusting temperature uniformity, wherein depositing a serpentine film heating wire on a two-dimensional flat thin sheet substrate; forming the serpentine film heating wire by several parallel heating sections and connecting lines; along a longitudinal direction of the substrate adjusting the adjacent spacings between the heating sections or line widths of the heating sections separately or in combination to improve the temperature uniformity in the longitudinal direction; along a transverse direction of the substrate adjusting the shape of every heating section to be wide in center and narrow at two ends to improve the temperature uniformity in the transverse direction.

9. The method for adjusting the temperature uniformity, as recited in claim 8, wherein in the longitudinal direction of the substrate the spacings between the neighboring heating sections are wide in the center of the substrate and narrow at two sides of the substrate.

10. The method for adjusting the temperature uniformity, as recited in claim 8, wherein in the longitudinal direction of the substrate the line widths of different heating sections are wide in the center of the substrate and narrow at two sides of the substrate.
